(19) United States
(12) Patent Application Publication
(10) Pub. No.: US 2024/0140152 A1
(43) Pub. Date: May 2, 2024

(54) System and Method for Determining Tongue Weight

(71) Applicant: Hall Logic, Inc., Provo, UT (US)

(72) Inventors: Michael Hall, Provo, UT (US); Jacob Ovard, Provo, UT (US); Thomas Corie, Springville, UT (US); Chandler Flinders, Provo, UT (US)

(73) Assignee: Hall Logic, Inc., Provo, UT (US)

(21) Appl. No.: 18/498,477

(22) Filed: Oct. 31, 2023

Related U.S. Application Data
(60) Provisional application No. 63/381,646, filed on Oct. 31, 2022.

(51) Int. Cl. B60D 1/24

(52) U.S. Cl. CPC B60D 1/248

(57) ABSTRACT

A system for measuring the tongue weight of a trailer attached to a hitching component of a vehicle is disclosed. The system includes a smart device comprising a sensor for determining the angle of the smart device with respect to horizontal and an app running on the smart device. The app is configured to take a signal from the sensor when the smart device is resting on a surface of the vehicle at a point in time when the trailer is not hitched to the vehicle and store a value “Angle Unhitched,” corresponding to the angle of the vehicle without the trailer hitched. The app is also configured to take a signal from the sensor when the smart device is resting on the surface of the vehicle at a point in time when the trailer is hitched to the vehicle and store a value “Angle Hitched,” corresponding to the angle of the vehicle without the trailer hitch attached. The app is further configured to obtain a value “VSC,” corresponding to stiffness of suspension for the vehicle, and reflecting a change in angle per unit of weight applied to the hitching component. The app is configured to then calculate a value “TW,” representing the tongue weight of the trailer when hitched to the vehicle, by using the formula: TW=[(a sin(Angle Unhitched)−a sin(Angle Hitched)]×VSC, where a sin is the arcsine. The app is also configured to report the value TW to a user of the smart device.

### RELATED APPLICATIONS

This non-provisional application claims priority to the pending U.S. Provisional Application No. 63/381,646, filed Oct. 31, 2022, entitled System and Method for Determining Tongue Weight, the entire contents of which are incorporated herein by this reference.

### TECHNICAL FIELD

The invention relates to the field of towing, and more specifically to systems for determining trailer tongue weight.

### BACKGROUND

When hitching a trailer to a vehicle, it is important that the weight of the trailer tongue be within the proper range. If too much weight is pressing down on the vehicle's towing ball, it can cause the rear of the vehicle to drop down and the front of the vehicle to raise up. Naturally, this is an unsafe condition, as the front wheels may lose traction and steering may be affected. On the other hand, if the trailer tongue is too light or even pulling the trailer ball upward, that can cause other safety problems for the towing vehicle. The common rule of thumb is about 10-15% of the total trailer weight.

While systems exist for measuring the tongue weight of a trailer, they are typically complicated and inconvenient. See, for example, U.S. Pat. No. 10,596,869, entitled “Ball Assembly for Measuring Tongue Weight of a Trailer;” and U.S. Pat. No. 7,960,659, entitled “Trailer Tongue Weight Measurement System.” What is needed is a more efficient method of determining optimal trailer tongue weight.

### SUMMARY OF THE INVENTION

In a first aspect, the disclosure provides a system for measuring the tongue weight of a trailer attached to a hitching component of a vehicle. The system includes a smart device comprising a sensor for determining the angle of the smart device with respect to horizontal and an app running on the smart device. The app is configured to take a signal from the sensor when the smart device is resting on a surface of the vehicle at a point in time when the trailer is not hitched to the vehicle and store a value “Angle Unhitched,” corresponding to the angle of the vehicle without the trailer hitched. The app is also configured to take a signal from the sensor when the smart device is resting on the surface of the vehicle at a point in time when the trailer is hitched to the vehicle and store a value “Angle Hitched,” corresponding to the angle of the vehicle without the trailer hitch attached. The app is further configured to obtain a value “VSC,” corresponding to stiffness of suspension for the vehicle, and reflecting a change in angle per unit of weight applied to the hitching component. The app is configured to then calculate a value “TW,” representing the tongue weight of the trailer when hitched to the vehicle, by using the formula:

TW=[(a sin(Angle Unhitched)−a sin(Angle Hitched)]×VSC

where a sin is the arcsine in degrees

The app is also configured to report the value TW to a user of the smart device.

In a second aspect, the disclosure provides a method for measuring the tongue

weight of a trailer attached to a hitching component of a vehicle.

Further aspects and embodiments are provided in the foregoing drawings, detailed description and claims. In one embodiment of the invention, a system for measuring the tongue weight of a trailer attached to a hitching component of a vehicle comprising a smart device may include a sensor for determining the angle of the smart device with respect to horizontal.

It may also include an app running on the smart device, the app configured to take a signal from the sensor when the smart device is resting on a surface of the vehicle at a point in time when the trailer is not hitched to the vehicle and store a value “Angle Unhitched,” corresponding to the angle of the vehicle without the trailer hitched. It may also take a signal from the sensor when the smart device is resting on the surface of the vehicle at a point in time when the trailer is hitched to the vehicle and store a value “Angle Hitched,” corresponding to the angle of the vehicle without the trailer hitch attached. Additionally, the app may obtain a value “VSC,” corresponding to stiffness of suspension for the vehicle, and reflecting a change in angle per unit of weight applied to the hitching component of the vehicle. The app may calculate a value “TW,” representing the tongue weight of the trailer when hitched to the vehicle, by using the formula: TW=[(a sin(Angle Unhitched)−a sin(Angle Hitched)]×VSC, where a sin is the arcsine; and report the value TW to a user of the smart device.

In another embodiment of the invention, the system may comprise an app configured to receive an input representing GVW of the trailer and calculate whether the calculated value for TW is within an acceptable percentage of the GVW of the trailer and report to the user whether the TW is within or not within of the acceptable percentage of the GVW of the trailer. For example, an acceptable percentage may be between 10 and 15 percent of the GVW of the trailer.

In another embodiment of the invention the system may use the app to provide instructions to the user when the TW is not within the acceptable percentage of the GVW of the trailer. In an additional embodiment the app receiving the input representing GVW of the trailer may be accomplished by scanning a sticker on the trailer and adding weights for items loaded on the trailer. Also, adding weights for items loaded on the trailer may be facilitated by selecting items from a menu of possible items on the app.

The system value VSC may be obtained by inputting the VIN into the app, whereupon the app obtains the VSC from a lookup table based on the VIN. The VSC may also be obtained from a sticker comprising a table of values mounted on the vehicle.

In yet another embodiment, the system may provide an app configured to receive an input representing GVW of the trailer, then calculate whether the calculated value for TW is within an acceptable percentage of the GVW of the trailer. The app may report to the user whether the TW is within or not within the acceptable percentage of the GVW of the trailer; receive an input representing the GVWR of the vehicle; receive an input representing the GVW of the vehicle; add the GVW of the vehicle and the GVW of the trailer to obtain a combined GVW; compare the combined GVW to the GVWR; and report to the user whether the combined GVW is greater or less than the GVWR.

Additionally, the system may provide an app adapted to receive an input representing the GVWR of the vehicle and the app also adapted to receive an input representing the GVW of the vehicle. These values may be stored within the app or may be obtained by scanning a sticker on the vehicle and adding weights for items loaded in or on the vehicle.

The app may be optimized by adding predetermined weights for items loaded in or on the vehicle and by selecting items from a menu of possible items on the app.

In the event that the app determines that there is a TW overload or other mismatch, the app may be further configured to provide instructions to the user when the TW is not within the acceptable percentage and provide instructions to the user when the combined GVW is greater than the GVWR.

The system may be further configured, and the app may be further configured to provide instructions to the user on scanning the sticker on the vehicle and scanning the sticker on the trailer. The instructions may include suggestions to the user on equipment to purchase when the TW is not within the acceptable percentage. The instructions may also include suggestions on which equipment may be removed and the order of removal in order to bring the TW into an acceptable percentage.

The system may include an inventory on the app of the equipment that may be purchased from or otherwise provided by a company. Also, the app may be configured to allow the user to purchase the equipment from the company or another vendor according to the system's preferred availability.

Additional methods incorporating the embodiments of the present invention may include any of the following modifications and optimizations that are further described in the drawings. For example, a method for measuring the tongue weight of a trailer attached to a hitching component of a vehicle may comprise providing a smart device comprising a sensor for determining the angle of the smart device with respect to horizontal. Providing the smart device with an app adapted to run on the device and configured to complete the following steps: taking a signal from the sensor when the smart device is resting on a surface of the vehicle at a point in time when the trailer is not hitched to the vehicle and store a value “Angle Unhitched,” corresponding to the angle of the vehicle without the trailer hitched;
taking a signal from the sensor when the smart device is resting on the surface of the vehicle at a point in time when the trailer is hitched to the vehicle and store a value “Angle Hitched,” corresponding to the angle of the vehicle without the trailer hitch attached;
obtaining a value “VSC,” corresponding to stiffness of suspension for the vehicle, and reflecting a change in angle per unit of weight applied to the hitching component of the vehicle;
calculating a value “TW,” representing the tongue weight of the trailer when hitched to the vehicle, by using the formula: TW=[(a sin(Angle Unhitched)−a sin(Angle Hitched)]×VSC. where a sin is the arcsine; and reporting the value TW to a user of the smart device.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a screenshot of an app used in the present invention, depicting the first step.

FIG. 2 is a screenshot of an app used in the present invention, depicting the second step.

FIG. 3 is a screenshot of an app used in the present invention, depicting the third step.

FIG. 4 is a screenshot of an app used in the present invention, depicting the fourth step.

FIG. 5 is a screenshot of an app used in the present invention, depicting the fifth step.

FIG. 6 is a screenshot of an app used in the present invention, depicting the sixth step.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “smart device” is meant to refer to a cellular phone, tablet or similar device that includes an accelerometer or other means for sensing the angle of the device with respect to the horizontal.

As used herein, “app” refers to an application or piece of software, which is programmed to carry out the functions described.

As used herein, “VIN” refers to the Vehicle Identification Number for the vehicle.

As used herein, “GVW” is the Gross Vehicle Weight, i.e. the weight of the vehicle, either the towing vehicle or the trailer, at a point in time.

As used herein, “GVWR” is the Gross Vehicle Weight Rating, i.e. the maximum weight capacity of a vehicle. When referring to a trailer, the GVWR includes the weight of the trailer, along with any items loaded on it.

As used herein, “Towing Capacity” is the maximum weight of a trailer that a

vehicle can tow.

As used herein, “hitching component” refers to the component attached to the towing vehicle on which the trailer tongue rests when towing. For example, a trailer hitch ball is commonly attached to the back of a truck or car. Also, a pin or king pin is used for towing a “5^{th} wheel” type trailer by a pickup truck.

In its preferred embodiment, the invention utilizes sensors inside the phone to calculate many measurements important to safely towing a trailer. These include tongue weight, pin weight, payload, and Weight Distribution. Accelerometers are used in this embodiment, although magnetometers and gyro's may also be used together with accelerometers or alone to calculate the vehicles pitch angle. The invention also helps the customer determine trailer and vehicle weight to give context to the other measurements, to help the customer make better decisions.

In carrying out the method of the invention, the user is instructed to lay the phone down on the floor mat, oriented longitudinally with the vehicle. The accelerometer that lies along the longitudinal axis of the vehicle is used to sense the tilt, typically the Y accelerometer. It is noted that, in this description, the Y axis is the vertical axis, namely the axis that passes from the bottom to the top of the phone. The X axis passes through the width of the from, from one side to the other. The Z axis passes from the front to the back of the phone.

The pitch angle is calculated:

Alpha=a sin(acceleration), where “a sin” is the arcsine in degrees.

The tongue weight may be calculated by sensing the change in pitch when a load is placed on the rear hitch ball.

Tongue Weight=[(a sin(acccelinit)−a sin(accel)]*TW Coeff.

Where:
Acceleration: The accelerometer that lies along the longitudinal axis of the vehicle.
AccelInit: The initial acceleration of the accelerometer in the longitudinal axis of the vehicle, before tongue weight is applied.
TWCoeff: Tongue Weight coefficient, in lbf/deg. This measure the suspension stiffness of the vehicle, and is unique to each vehicle model.
The value for TWCoeff is found by sending the vehicles VIN (Vehicle Identification Number) to a database to find the suspension stiffness.

In addition to tongue weight sensing, the app guides the user through discovering the trailer weight and vehicle weight. Thus, the user is given more context than just a measurement. The trailer weight in particular is needed to determine the optimum tongue weight. The app first helps the customer find the inputs to discover the trailer weight. From the trailer weight, an optimum tongue weight is calculated (generally between 10 and 15%*Trailer weight, most preferably about 12.5%*Trailer weight). When the tongue weight is measured, the app is able to signal and message the user if they are in the correct range. If tongue weight is light, the app instructs the user to move contents from the back of the trailer to the front.

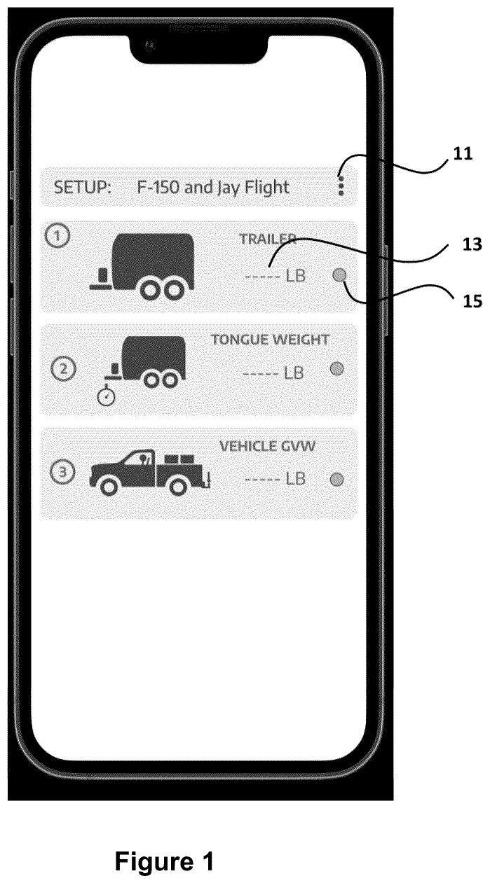

FIGS. 1-6 are screenshots from the preferred app.

FIG. 1 is a screenshot of an opening screen in the app. In setup mode, the user inputs a name for the combination of vehicle and trailer, 11. In space 13, the weight of the trailer (GVW) will be calculated. When that weight is calculated and within the acceptable range, the circle 15 will turn green. Similar spaces and circles are provided for the tongue weight and the GVW of the vehicle are provided on this same screen.

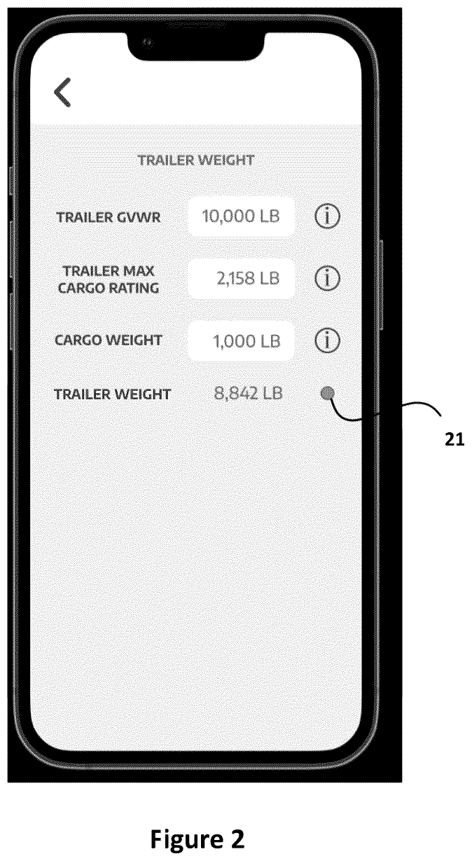

FIG. 2 is a second screenshot from the app. This screen shows the GVWR of the trailer. Alternatively, or additionally, the screen could show the maximum payload rating. This number is preferably obtained by scanning a sticker on the trailer. Alternatively, it can be inputted manually by the user. The screen also shows the maximum cargo rating for the trailer. Again, this is preferably obtained by scanning a sticker on the trailer, or else by manual input. The weight of the cargo is also input into the app. Preferably, this is done by providing a menu of possible items that could be loaded on the trailer and having the user simply select the items that are actually loaded on the trailer. The weight of the loaded trailer is obtained by adding the cargo weight to the trailer weight (see the first screenshot). When this value for the loaded trailer weight is less than or equal to the trailer's GVWR, the circle 21 is green. Otherwise, if the loaded trailer weight is greater than the trailer's GVWR, the circle would turn red. The app may also provide instructions to the user, such as removing certain items of cargo.

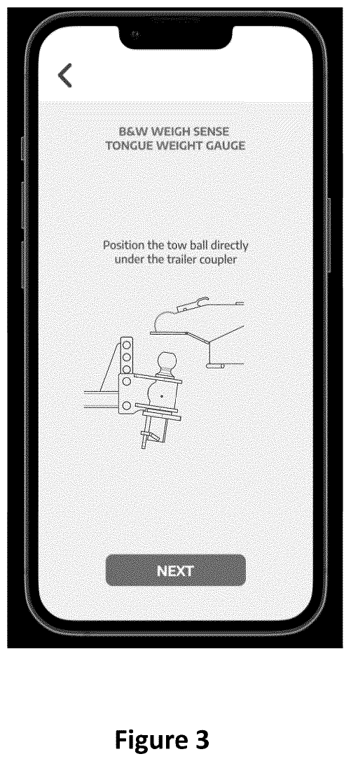

FIG. 3 is a screenshot of the app instructing the user to align the trailer over the ball mount of the vehicle's hitch.

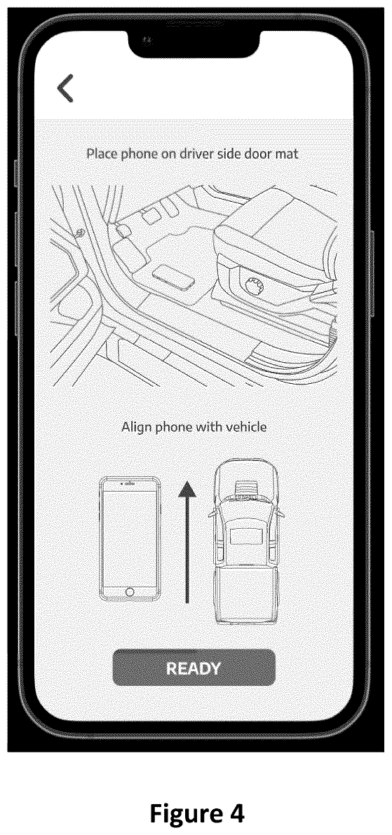

FIG. 4 is a screenshot of the app instructing the user to take the next step of placing the smart device on driver side door mat. Other locations on the vehicle can be used, such as on the rear bumper, on the truck bed or tailgate or on the roof. Nevertheless, the location is preferred, as it provides greater security for the smart device and lessens the chance of the smart device being disturbed during the measurements. While resting on the vehicle, the smart device senses an angle with respect to horizontal BEFORE the trailer tongue is lowered onto the hitch. This angle is stored by the app as “Angle Unhitched.” The app preferably instructs the user to tap an icon on the screen to capture this angle. To keep the user's touching the screen from interfering with the angle capture, the app records the measured angle a few seconds before or, preferably, after the touching.

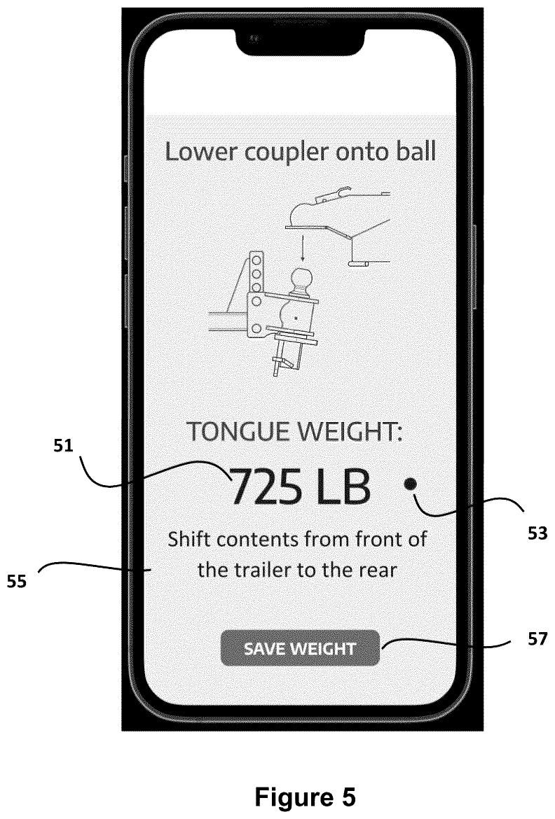

FIG. 5 is a screenshot of the app instructing the user to lower the trailer tongue coupler onto the ball of the vehicle hitch. Once that is accomplished and the full weight of the trailer tongue is supported by the ball, the user then taps an icon on the screen to capture the value of “Angle Hitched” for the app. Again, to keep the user's touching the screen from interfering with the angle capture, the app actually captures a value for the angle a few seconds before the touching or a few seconds after the touching.

As seen at 51, the app has calculated the tongue weight, based on the Angle Unhitched, the Angle Hitched and the VSC for the vehicle, as described above. That number is reported at 51. Preferably, if the value is within the acceptable range, the number is reported in green and the circle is green. If, on the other hand, and as depicted, the tongue weight value is outside the range, the number is reported in red and the circle 53 is red. Preferably, if the tongue weight is too high, the app also provides the instruction 55 to shift contents from the front of the trailer to the rear, i.e. behind the axle(s) of the trailer.

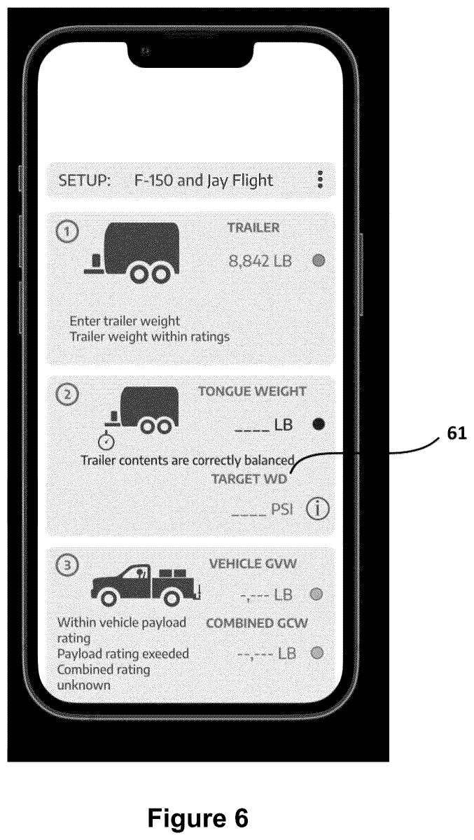

FIG. 6 is another screenshot from the app. This shows that the loaded trailer weight is within spec, so the circle is green. The screen also shows the tongue weight, red if it is out of range. The screen also shows a calculated value 61 for an adjustment of a weight distribution device.

This screenshot in FIG. 6 also shows a space to display the Vehicle's GVW and a space to show whether the vehicle's GVWR has been exceeded.

The invention has been described with reference to various specific and preferred embodiments and techniques. Nevertheless, it is understood that many variations and modifications may be made while remaining within the spirit and scope of the invention.

What is claimed is:

1. A system for measuring the tongue weight of a trailer attached to a hitching component of a vehicle comprising:
a smart device comprising a sensor for determining the angle of the smart device with respect to horizontal; and
an app running on the smart device, the app configured to
take a signal from the sensor when the smart device is resting on a surface of the vehicle at a point in time when the trailer is not hitched to the vehicle and store a value “Angle Unhitched,” corresponding to the angle of the vehicle without the trailer hitched;
take a signal from the sensor when the smart device is resting on the surface of the vehicle at a point in time when the trailer is hitched to the vehicle and store a value “Angle Hitched,” corresponding to the angle of the vehicle without the trailer hitch attached;
obtain a value “VSC,” corresponding to stiffness of suspension for the vehicle, and reflecting a change in angle per unit of weight applied to the hitching component of the vehicle;
calculate a value “TW,” representing the tongue weight of the trailer when hitched to the vehicle, by using the formula: TW=[(a sin(Angle Unhitched)−a sin(Angle Hitched)]×VSC, where a sin is the arcsine; and
report the value TW to a user of the smart device.

2. The system of claim 1, wherein the app is also configured to:
receive an input representing GVW of the trailer;
calculate whether the calculated value for TW is within an acceptable percentage of the GVW of the trailer; and
report to the user whether the TW is within or not within the acceptable percentage of the GVW of the trailer.

3. The system of claim 2, wherein the acceptable percentage is between 10 and 15 percent.

4. The system of claim 2, wherein the app is further configured to provide instructions to the user when the TW is not within the acceptable percentage.

5. The system of claim 2, wherein the app receiving the input representing GVW of the trailer is accomplished by scanning a sticker on the trailer and adding weights for items loaded on the trailer.

6. The system of claim 2, wherein the adding weights for items loaded on the trailer is facilitated by selecting items from a menu of possible items on the app.

7. The system of claim 1, wherein the value VSC is obtained by inputting the VIN into the app, whereupon the app obtains the VSC from a lookup table based on the VIN.

8. The system of claim 2, wherein the app is also configured to:
receive an input representing GVW of the trailer;
calculate whether the calculated value for TW is within an acceptable percentage of the GVW of the trailer;
report to the user whether the TW is within or not within the acceptable percentage of the GVW of the trailer;
receive an input representing the GVWR of the vehicle;
receive an input representing the GVW of the vehicle;
add the GVW of the vehicle and the GVW of the trailer to obtain a combined GVW;
compare the combined GVW to the GVWR; and
report to the user whether the combined GVW is greater or less than the GVWR.

9. The system of claim 8, wherein the app receiving the input representing the GVWR of the vehicle and the app receiving the input representing the GVW of the vehicle are accomplished by scanning a sticker on the vehicle and adding weights for items loaded in or on the vehicle.

10. The system of claim 5, wherein the adding weights for items loaded in or on the vehicle is facilitated by selecting items from a menu of possible items on the app.

11. The system of claim 8, wherein the app is further configured to
provide instructions to the user when the TW is not within the acceptable percentage; and
provide instructions to the user when the combined GVW is greater than the GVWR.

12. The system of claim 9, wherein the app is further configured to provide instruction to the user on scanning the sticker on the vehicle and scanning the sticker on the trailer.

13. The system of claim 9, wherein the app is further configured to provide suggestions to the user on equipment to purchase when the TW is not within the acceptable percentage.

14. The system of claim 13, wherein the app and the equipment to purchase are provided by a company.

15. The system of claim 13, wherein app is further configured to allow the user to purchase the equipment from the company.

16. A method for measuring the tongue weight of a trailer attached to a hitching component of a vehicle comprising:
providing a smart device comprising a sensor for determining the angle of the smart device with respect to horizontal;
providing an app running on the smart device, the app configured to complete the following steps:
taking a signal from the sensor when the smart device is resting on a surface of the vehicle at a point in time when the trailer is not hitched to the vehicle and store a value “Angle Unhitched,” corresponding to the angle of the vehicle without the trailer hitched;
taking a signal from the sensor when the smart device is resting on the surface of the vehicle at a point in time when the trailer is hitched to the vehicle and store a value “Angle Hitched,” corresponding to the angle of the vehicle without the trailer hitch attached;
obtaining a value “VSC,” corresponding to stiffness of suspension for the vehicle, and reflecting a change in angle per unit of weight applied to the hitching component of the vehicle;
calculating a value “TW,” representing the tongue weight of the trailer when hitched to the vehicle, by using the formula: TW=[(a sin(Angle Unhitched)−a sin(Angle Hitched)]×VSC. where a sin is the arcsine; and
reporting the value TW to a user of the smart device.

17. The method of claim 16, wherein the app is also configured to:
receive an input representing GVW of the trailer;
calculate whether the calculated value for TW is within an acceptable percentage of the GVW of the trailer; and
report to the user whether the TW is within or not within the acceptable percentage of the GVW of the trailer.

18. The method of claim 17, wherein the acceptable percentage is between 10 and 15 percent.

19. The method of claim 17, wherein the app is further configured to provide instructions to the user when the TW is not within the acceptable percentage.

20. The method of claim 17, wherein the app receiving the input representing GVW of the trailer is accomplished by scanning a sticker on the trailer and adding weights for items loaded on the trailer.
